(19) United States
(12) Patent Application Publication
(10) Pub. No.: US 2010/0213329 A1
(43) Pub. Date: Aug. 26, 2010

(54) LAPTOP COMPUTER STAND

(76) Inventors: Kenneth Petruzzelli, Mahopac, NY (US); Katharine Petruzzelli, Mahopac, NY (US)

Correspondence Address: James Ray & Associates, 2640 Pitcairn Road, Monroeville, PA, 15146, US

(21) Appl. No.: 12/713,494

(22) Filed: Feb. 26, 2010

Related U.S. Application Data
(60) Provisional application No. 61/155,663, filed on Feb. 26, 2009.

(51) Int. Cl. F16M 11/04

(52) U.S. Cl. 248/176.1

(57) ABSTRACT

The present invention in several embodiments is an apparatus that can securely hold one's laptop computer during use while reducing the chance of the unit overheating. This item is preferably constructed of Plexiglas, a transparent thermoplastic, a polymer or a suitable, durable material. A laptop computer may be set on the apparatus of the present invention and fit into place with the rubber feet on the computer. This unit may raise the computer off the lap or furniture allowing better air circulation around it, keeping it cool. This portable stand may also have an area built in that can hold papers if desired by the user.

### CROSS REFERENCE TO RELATED APPLICATION

This patent application is related to and claims priority from U.S. Provisional Patent Application Ser. No. 61/155,663 filed Feb. 26, 2009.

### FIELD OF THE INVENTION

This invention generally pertains to laptop computer accessories. Specifically, the present invention relates to an apparatus for aiding in the ventilation of a laptop computer and for aiding in insulating said laptop computer from a user of the laptop computer.

### BACKGROUND OF THE INVENTION

The invention is particularly applicable to putting laptop computer accessories and will be described with particular reference thereto.

Many people utilize their laptop computer on their legs while sitting or reclining. The computer may easily become overheated because of a lack of air circulation. This may cause the computer to shut down, possibly causing the user to lose documents and unsaved material. Excessive overheating may cause damage to the circuit board or other components and create other problems for the user. Provided in this disclosure is a simple way for laptop computer users to prevent their unit from overheating while keeping the unit stable during use. The apparatus of the present invention may assist individuals in comfortably using the item more often with a reduced risk of damage. The present invention also insulates the user from the computer if placed on the user's lap.

### SUMMARY OF THE INVENTION

The present invention in several embodiments is a lightweight device that can be utilized to stabilize a laptop during use while preventing the unit from overheating. This unique product can assist individuals in comfortably using their laptop while sitting or reclining. This innovative item is ideal for use by anyone looking for a simple way to stabilize their laptop and comfortably access the keyboard while preventing the unit from becoming excessively heated.

The present invention in several embodiments is an apparatus that can securely hold one's laptop computer during use while reducing the chance of the unit overheating. This item is preferably constructed of Plexiglas, a transparent thermoplastic, a polymer or a suitable, durable material. The apparatus of the present invention unit may measure approximately 15 ½″ by 13″ by 3/16″. The dimensions of the current invention could vary depending of the size and proportions of the laptop computer to be accommodated. The entire item may weight approximately 2 ½ lbs. A laptop computer may be set on the apparatus of the present invention and fit into place with the rubber feet on the computer. This unit may raise the computer off the lap or furniture allowing better air circulation around it, keeping it cool. This portable stand may also have an area built in that can hold papers if desired by the user. This item may be produced in various colors to accommodate user preferences.

### OBJECTS OF THE INVENTION

It is, therefore, one of the primary objects of the present invention is to provide an improved laptop computer stand. Another object of the present invention is to provide an apparatus for passively improving the ventilation of a laptop computer.

Still another object of the present invention is to provide an apparatus for insulating a person from a laptop computer. Still yet another object of the present invention is to provide an apparatus for thermally insulating a person from a laptop computer.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective view of one embodiment of the present invention.

FIG. 2 is a general perspective view of the invention being used on a flat surface.

FIG. 3 is a general perspective view of the invention being used on person's lap.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

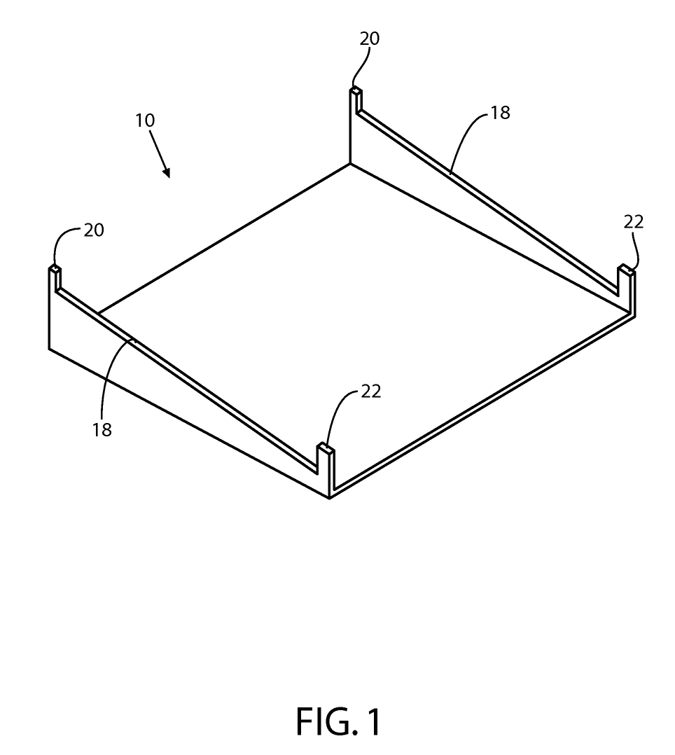

Reference is now made to FIG. 1 which shows a general perspective view of one embodiment of the present invention. The present invention is an apparatus, generally designated 10, that can be utilized to aid in the ventilation of a laptop computer 12 and to aid in insulating said laptop computer from a user 14. In a preferred embodiment the apparatus 10 is constructed as a single continuous piece comprising a substantially flat base 16, inclined side rails 18, rear tabs 20 and frontal tabs 22. In several preferred embodiments inclined side rails 18 have rubberized material attached to each side rail 18 for contacting a laptop computer to prevent it from slipping on the present invention 10. The rubberized material could be a rubber gasket type material, spray on rubber material, or the like.

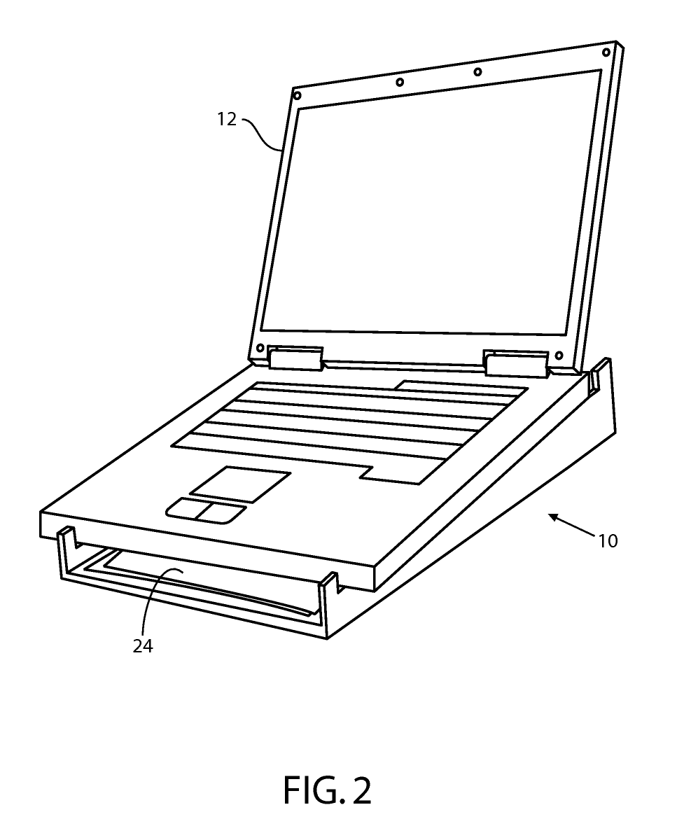

Reference is now made to FIG. 2 which shows a general perspective view of the invention being used on a flat surface.

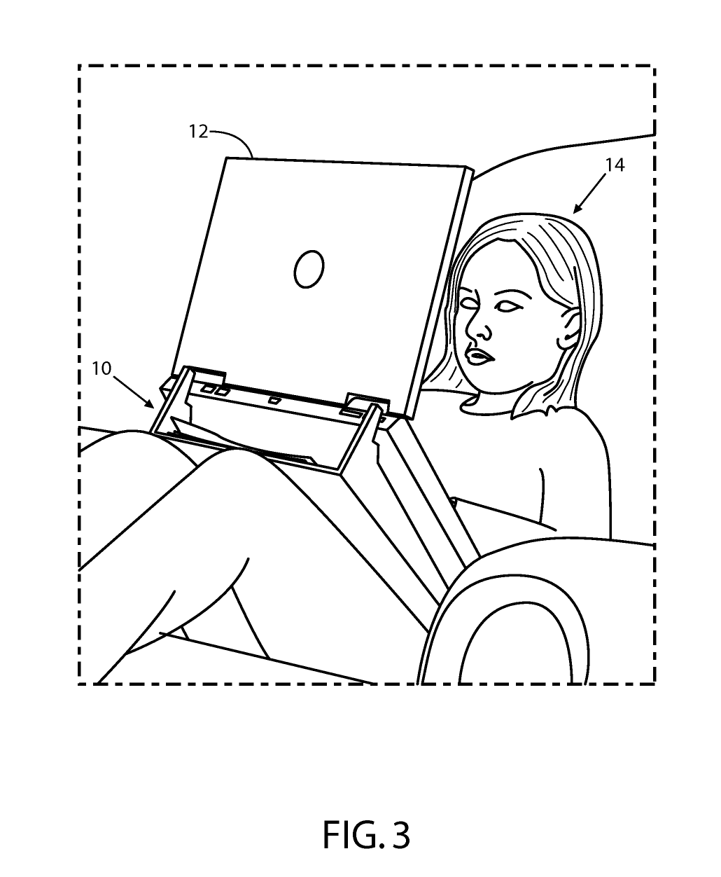

Laptop computer 12 rests on apparatus 10 and storage area 24 is located underneath laptop computer 12 on apparatus 10. FIG. 2 is provided to demonstrate the use of the apparatus as a storage device as well as a laptop computer ventilation device. Reference is now made to FIG. 3 which shows a general perspective view of the invention being used on person's lap. Laptop computer 12 rests on apparatus 10 which rests on user's 14 lap. Rear tabs 20 and frontal tabs 22 prevent laptop computer 12 from sliding off the apparatus 10, thus allowing the user 14 to comfortably incline their lap while using laptop computer 12.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A laptop computer stand comprising:
a substantially flat base,
a pair of substantially parallel inclined side rails,
a first rear tab fixed to a rear portion of a first inclined side rail of said pair of substantially parallel inclined side rails,
a second rear tab fixed to a rear portion of a second inclined side rail of said pair of substantially parallel inclined side rails,
a first frontal tab fixed to a frontal portion of a first inclined side rail of said pair of substantially parallel inclined side rails,
a second frontal tab fixed to a frontal portion of a second inclined side rail of said pair of substantially parallel inclined side rails,
wherein said pair of substantially parallel inclined side rails project outward from said substantially flat base.

2. The laptop computer stand of claim 1, further comprising a rubberized material fixed to said pair of substantially parallel inclined side rails.

3. The laptop computer stand of claim 1, further comprising a rubberized material fixed to, at least in part, said pair of substantially parallel inclined side rails.

4. The laptop computer stand of claim 1, wherein the stand is constructed of a polymer.

5. The laptop computer stand of claim 1, wherein the stand is constructed of a thermoplastic.

6. The laptop computer stand of claim 1, wherein the stand is constructed of a transparent thermoplastic.

7. The laptop computer stand of claim 1, wherein the stand is constructed as a single unitary element.

8. The laptop computer stand of claim 1, wherein said pair of substantially parallel inclined side rails are positioned substantially perpendicular to said substantially flat base.
